(19) United States
(12) Patent Application Publication
(10) Pub. No.: US 2004/0013700 A1
(43) Pub. Date: Jan. 22, 2004

(54) Compositions for treating ectoparasite infections and methods for their application

(76) Inventor: Michael J. Precopio, Collegeville, PA (US)

Correspondence Address: HENRY E. MILLSON, JR., 675 GOLDEN HAWK DRIVE, PRESCOTT, AZ, 86301, US

(21) Appl. No.: 10/382,188

(22) Filed: Mar. 4, 2003

Related U.S. Application Data
(63) Continuation-in-part of application No. 10/195,048, filed on Jul. 11, 2002.

(51) Int. Cl. A01N 25/00; A01N 31/00

(52) U.S. Cl. 424/405; 514/730

(57) ABSTRACT

Compositions and methods for treating ectoparasite and their egg infestations on animal skin and hair, wherein the compositions contain at least one monohydric aralkyl alcohol in a quantity sufficient to provide pesticidal activity.

### BENEFIT OF EARLIER FILING DATE UNDER 37 C.F.R. 1.78 (A)(4)

This application is a continuation-in-part-of application Ser. No. 10/195,048, filed on Jul. 11, 2002.

### FIELD OF THE INVENTION

This invention relates to compositions and methods for treating ectoparasite infestations on mammalian bodies, particularly human head lice infestations.

### BACKGROUND OF THE INVENTION

Current methods for the treatment of ectoparasites, e.g. lice, typically utilize somewhat toxic insecticidal compositions which are available in both prescription and over-the-counter formulations. Such compositions generally include one or more of the active ingredients benzyl benzoate, pyrethrin, permithrin, and lindane. Dispensing formulations include lotions, creams, shampoos, cream rinses, and gels.

However, increasing numbers of ectoparasite infections, especially head lice, that are resistant to the above insecticides have been reported in the medical literature.

Alternative insecticidal treatments such as the use of malathion, ivermectin, and a combination of trimethoprim and sulfamethazole have been tried, but usually only with mixed results.

Another approach that has been reported and which is at least partially effective is the use of a topical petrolatum-containing product, which suffocate the parasites when left on the head for a prolonged period of time. However, removal of the petrolatum from the head and hair has proven to be a difficult problem, often taking about ten days for complete removal.

Oil based occlusive treatments have been observed to significantly immobilize and coat the lice long enough for asphyxiation to occur. However, some adult lice survived even after an overnight treatment. Meinking, T L, Burkhart C G, Burkhart C N, Ectoparasitic Disease in Dermatology: Reassessment of Scabies and Pediculosis, Advances in Dermatology, Chapter 3, pp 99, Mosby Inc. 1999.

Head lice have been on the increase in the recent past, in large part due to the fact that they have become more tolerant or resistant to conventional treatments. For this reason children are being over-treated with pesticide-containing products as well as other unconventional treatments in an effort to control this epidemic. Many parents and health professionals have turned to unproven and generally ineffective alternative products such as mayonnaise, olive oil, etc. Unfortunately, others have turned to vary dangerous alternatives such as gasoline, kerosene or traumatizing measures such as head shaving.

It was recently discovered by the present inventor that ectoparasites on animal skin can be treated successfully by a method comprising the steps of:

I) applying to the skin affected by ectoparasites a water-soluble or water-dispersible, substantially air-impermeable liquid barrier composition;

II) leaving the composition in contact with the skin until the ectoparasites have been killed by suffocation; and

III) removing the composition and the dead ectoparasites from the skin, See U.S. Pat. Nos. 5,858,383 and 6,139,859.

There are, however, no safe and acceptable compositions that have proven to be effective against both ectoparasites and their eggs, known as nits for lice, have been developed to date.

### SUMMARY OF THE INVENTION

Other than in the operating examples, or where otherwise indicated, all numbers expressing quantities of ingredients used herein are to be understood as modified in all instances by the term “about”.

It has now been discovered that water-soluble or water-dispersible liquid or gel-form compositions that consist of, or contain, monohydric aralkyl alcohols have marked pesticidal activity against ectoparasites, especially lice, and in addition, are highly effective against ectoparasite eggs.

The present compositions also have very low toxicity, i.e. are essentially nontoxic when applied to human and other animal skin and hair, especially those in which the monohydric alcohol is present in 30% by weight or less. The present compositions are free from pesticidal components other than the monohydric aralkyl alcohols. It is, of course, possible to include other pesticidal components, but such components are unnecessary and will most likely result in toxicity and other problems.

The compositions of the invention can be air-impermeable, or contain air in the composition.

However, it has also been discovered that water-soluble or water-dispersible, substantially air-impermeable liquid barrier compositions that consist of or contain monohydric aralkyl alcohols effectively prevent the ectoparasites from closing their respiratory systems (breathing apparatus), called breathing spiracles in lice, as well as acting as effective pesticides against both lice and their nits.

Ectoparasites such as lice, especially head lice, can normally defend against asphyxiation for prolonged periods of time, even up to 12 hours, by closing their spiracles. With the above air-impermeable compositions of the invention death occurs in very much shorter periods of time, e.g. in less than 45 minutes, usually between 10 and 15 minutes, since the aralkyl alcohols prevent the ectoparasites from closing their breathing apparatus. This is much faster than expected since occlusion of the lice with other materials and compositions will take at least several hours to result in asphyxiation. It is believed that the above air-impermeable compositions of the invention function so rapidly by a combination of asphyxiation and pesticidal activity, resulting in a complete kill of the ectoparasites within a short period of time, e.g. 10 to 15 minutes or even less. In addition, the monohydric aralkyl alcohols, especially benzyl alcohol, are bacteriostatic.

An important advantage of using the above air-impermeable compositions of the invention is that the ectoparasites, e.g. lice, even if they were to become resistant to the pesticidal activity of the monohydric aralkyl alcohols, cannot become resistant to asphyxiation, since asphyxiation provides a kill ratio of 100%.

The invention also relates to the use of the compositions of the invention for treating ectoparasites and their eggs on animal skin and hair by a method comprising the steps of:

I) applying to skin and hair affected by ectoparasites an air-permeable, water-dispersible, pharmacologically acceptable composition comprising one or more aralkyl alcohols in a quantity sufficient to provide insecticidal activity against ectoparasites and their eggs, usually from 1 to 50% by weight, preferably from 2 to 30% by weight, more preferably from 5 to 20% by weight, and most preferably from 5 to 12% by weight based on the weight of the composition, wherein the composition preferably does not contain any pesticides other than the aralkyl alcohol(s);

II) leaving the composition in contact with the skin and hair until the ectoparasites and at least most of their eggs have been killed; and

III) removing the composition and the dead ectoparasites from the skin and hair.

The invention further relates to the use of the above air-impermeable compositions of the invention for treating ectoparasites and their eggs on animal skin and hair by a method of comprising the steps of:

I) applying to skin and hair affected by ectoparasites a water-soluble or water-dispersible, substantially air-impermeable, pharmacologically acceptable liquid barrier composition consisting of or containing one or more aralkyl alcohols in a quantity sufficient to provide insecticidal activity against the ectoparasites and their eggs and to suffocate the ectoparasites by preventing the ectoparasites from closing their respiratory systems and from obtaining oxygen, wherein the composition preferably does not contain any pesticides other than the aralkyl alcohol(s);

II) leaving the composition in contact with the skin and hair until the ectoparasites and at least most of their eggs have been killed; and

III) removing the composition and the dead ectoparasites from the skin and hair.

The monohydric aralkyl alcohols used in the compositions and methods of the invention are those in which the hydroxyl group is attached to an alkyl group. The aryl moiety is preferably a phenyl or substituted phenyl group, although other aryl groups such as those with multiple rings are also within the scope of the invention provided the resulting aralkyl alcohol is pharmacologically compatible when applied to animal skin and hair.

Preferred monohydric aralkyl alcohols of the invention are those having formula I below:

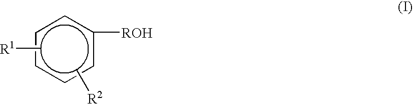

in which R is a C₁-C₁₂ straight or branched chain, saturated or olefinically unsaturated, alkylene group, and R¹ and R² are independently hydrogen, halogen (fluorine, chlorine, bromine, or iodine), C₁-C₄ alkyl, or C₁-C₄ alkoxy groups. Preferred compounds of formula I are those in which the R group is a C₁-C₆ saturated alkylene group, especially those wherein R¹ and R² are both hydrogen. The most preferred compound of formula I is benzyl alcohol. When the R group is an ethylenically unsaturated alkylene group, this group can also be referred to as an alkenylene group.

### DETAILED DESCRIPTION OF THE INVENTION

It is to be understood that the compositions employed in the methods of the invention described above kill the ectoparasites by insecticidal activity alone where the compositions are not air-impermeable, or by a combination of suffocation and pesticidal, e.g. pediculicidal, activity of the aralkyl alcohols where the compositions are air-impermeable as the only mechanisms of action, and are accordingly free from toxic pediculicides and other toxic ingredients. The ectoparasite eggs are also killed by the insecticidal activity of the aralkyl alcohols.

The ectoparasites and their eggs treated by the methods and compositions of the invention include lice, especially head lice (Pediculus humanus capitis), as well as the crab (pubic) louse (Phthirus pubis) and the body or clothing louse (Pediculus humanus humanus); and mites (chiggers, scabies and the like).

The animal skin treated by the methods of the present invention include any skin area infected by an ectoparasite, especially those covered by hair, such as the human scalp and pubic area. Also, household pets and other animals infected with ectoparasites can also be treated by the methods of the invention.

It should be noted that other monohydric alcohols such as alkanols, e.g. ethanol and isopropyl alcohol, and polyhydric alcohols such glycols and polyalkylene glycols may not be satisfactory for use in place of the monohydric aralkyl alcohols of formula I since they are either not effective or are not completely effective as pesticides and/or in preventing the respiratory system of the ectoparasites from closing within a reasonably short period of time, and in addition are not known to be effective against ectoparasite eggs.

The air-permeable compositions and the substantially air-impermeable, pharmacologically acceptable liquid barrier compositions consisting of or containing one or more monohydric aralkyl alcohols used in the practice of the invention include any such compositions that are compatible with the skin, i.e. those that contain no components that are toxic or carcinogenic to the skin or any other parts of the animal if absorbed through the skin, including those that cause dermatitis, skin irritation, itching, or the like.

By substantially air-impermeable is meant that the composition does not contain sufficient air nor does it permit air to penetrate the composition in a quantity that would prevent the composition from suffocating the ectoparasites. It is of course the lack of oxygen over a period of time that results in the suffocation of the ectoparasites. As discussed above, since the ectoparasites are killed by suffocation as well as pesticidal activity, they cannot become resistant to the air-impermeable compositions of the invention, unlike known compositions containing other pesticides.

The compositions of the invention must also be water-soluble or water dispersible so that they can be readily and rapidly removed by rinsing with water or other water-based liquid.

The compositions of the invention can be in the form of a free-flowing liquid to a viscous liquid or in the form of a gel.

The air-impermeable barrier compositions of the invention can be one or more aralkyl alcohols of formula I as the only component of the compositions.

It is preferable, however, to include at least one other component, i.e. compositions comprising component A) below and at least one of components B) through E):

A) at least one monohydric aralkyl alcohol;

B) a film forming agent;

C) a surface active agent;

D) a gelling or thickening agent;

E) water

For example, a composition comprising component A) plus all of components B) through E) in the form of a gel is one preferred air-impermeable composition of the invention.

Other optional components can include (but are not limited to) the following:

F) a neutralizing agent; and

G) a preservative.

Component A) is present in a pesticidal and respiratory system closing prevention quantity. Such quantity can range from 1 to 100%, but when other components are present usually ranges from 1 to 50% by weight, preferably from 2 to 30% by weight, more preferably from 5 to 20% by weight, and most preferably from 5 to 12% by weight, based on the weight of the liquid barrier composition. Quantities greater than 50% by weight in multi-component air-impermeable compositions are also effective, but are unnecessary. Quantities of less than 1% may be partially effective or may be effective over longer periods of time.

The air-permeable compositions of the invention can also contain one or more of the above components.

Component B) when present is present in from 1 to 25% by weight, preferably from 2 to 10% by weight, more preferably from 3 to 7% by weight, and most preferably from 4 to 6% by weight.

Component C) when present is present in from 0.1 to 10% by weight, preferably from 0.5 to 7% by weight, more preferably from 0.5 to 6% by weight, and most preferably from 0.8 to 5% by weight.

Component D) when present is present in from 0.05 to 5% by weight, preferably from 0.1 to 3% by weight, more preferably from 0.15 to 1% by weight, and most preferably from 0.2 to 0.35% by weight.

The remainder is generally component E), (water), optionally with small quantities of a neutralizing agent to adjust the pH to neutral or close to neutral, and/or other optional components such as small quantities (e.g. 0.01 to 1% by weight) of one or more preservatives.

The film forming agents of component B) include one or more of mineral oil (liquid petroleum) and other oils such as vegetable oils, e.g. cottonseed, coconut, palm, and the like, and other pharmacologically compatible oils such as other refined aliphatic petroleum oils, animal oils, e.g. fish oils, oleic acid, sperm oil, and oils derived from fruits and seeds such as corn, olive, soybean, cottonseed, safflower, and the like. Mineral oil is preferred.

The surface active agent of component C) is preferably one or more nonionic polysorbate surfactants (polyoxyethylene fatty acid esters), obtained by the esterfication of sorbitol with one or three molecules of a fatty acid, usually stearic, lauric, oleic, or palmitic acid, under conditions which cause splitting out of water from the sorbitol, leaving sorbitan fatty acid esters, i.e. a mixture of esters of the fatty acid with sorbitol and its mono- and di-anhydrides, and having a water content below 0.2%. The above ester mixture is then condensed with varying quantities of ethylene oxide, usually about 20 moles of ethylene oxide per mole of sorbitol. Examples of such polysorbate surfactants include, but are not limited to, Polysorbate 20 (polyoxyethylene (20) sorbitan monolaurate), Polysorbate 60 (polyoxyethylene (20) sorbitan monosterate), Polysorbate 80 (polyoxyethylene (20) sorbitan monooleate), Polysorbate 65 (polyoxyethylene (20) sorbitan tristearate), and Polysorbate 85 (polyoxyethylene (20) sorbitan trioleate).

In addition to the above polysorbate surfactants, surfactant sorbitan esters can also be used, either alone or in combination with a polysorbate. Sorbitan ester surfactants include sorbitan mono esters with a fatty acid, preferably stearic, lauric, oleic, or palmitic acid.

For use herein, it is preferred to use a mixture of polysorbate 80 and sorbitan monooleate, especially in a 50:50 or 60:40 weight ratio.

The surface active agent of component C) can also be one or more sugar-based surfactants, e.g. alkyl polyglycosides and glucosamides such as glucosamine and related compounds. The alkyl polyglycosides have the formula II below:

R₁O(R₂O)_{b}(Z)ₐ (II)

wherein R₁ is a monovalent organic radical having from about 6 to about 30 carbon atoms, preferably from 6 to 12 carbon atoms, and more preferably having an average of from 10 to 10.5 carbon atoms; R₂ is a divalent alkylene radical having from 2 to 4 carbon atoms; Z is saccharide residue having 5 or 6 carbon atoms; b is a number having a value from 0 to about 12; a is a number having a value from 1 to about 6, preferably from 1.2 to 2.2, and more preferably from 1.5 to 1.7. Preferred alkyl polyglycosides which can be used in the compositions according to the invention have the formula II wherein Z is or includes a glucose residue. Such alkyl polyglycosides are commercially available, for example; as TRITON® GC-110, an oligmeric D-glucopyranose decyl octyl glycoside from Union Carbide Corporation, and APG®, GLUCOPON®, or PLANTAREN® surfactants from Cognis Corporation, Ambler, Pa., 19002. Examples of the Cognis surfactants include but are not limited to:

1. GLUCOPON® 225DK Surfactant—an alkyl polyglycoside in which the alkyl group contains 8 to 10 carbon atoms and having an average degree of polymerization of 1.7.

2. GLUCOPON® 425N Surfactant—an alkyl polyglycoside in which the alkyl group contains 8 to 16 carbon atoms, having an average of 10.3 carbon atoms, and having an average degree of polymerization of 1.5.

3. GLUCOPON® 625UP Surfactant—an alkyl polyglycoside in which the alkyl group contains 12 to 16 carbon atoms and having an average degree of polymerization of 1.6.

4. APG® 325N Surfactant—an alkyl polyglycoside in which the alkyl group contains 9 to 11 carbon atoms and having an average degree of polymerization of 1.5.

5. GLUCOPON® 600UP Surfactant—an alkyl polyglycoside in which the alkyl group contains 12 to 16 carbon atoms and having an average degree of polymerization of 1.4.

6. PLANTAREN® 2000 Surfactant—a C₈-C₁₆ alkyl polyglycoside in which the alkyl group contains 8 to 16 carbon atoms and having an average degree of polymerization of 1.5.

7. PLANTAREN® 1300 Surfactant—a C₁₂-C₁₆ alkyl polyglycoside in which the alkyl group contains 12 to 16 carbon atoms and having an average degree of polymerization of 1.6.

8. GLUCOPON® 220N Surfactant—an alkyl polyglycoside in which the alkyl group contains 8 to 10 carbon atoms and having an average degree of polymerization of 1.5.

Other examples of alkyl polyglycosides that can be used herein include alkyl polyglycoside surfactants which are comprised of mixtures of compounds of formula II wherein Z represents a moiety derived from a reducing saccharide containing 5 or 6 carbon atoms; a is a number having a value from 1 to about 6; b is zero; and R¹ is an alkyl radical having from 8 to 20 carbon atoms. The compositions are characterized in that they have increased surfactant properties and an HLB in the range of about 10 to about 16 and a non-Flory distribution of glycosides, which is comprised of a mixture of an alkyl monoglycoside and a mixture of alkyl polyglycosides having varying degrees of polymerization of 2 and higher in progressively decreasing amounts, in which the amount by weight of polyglycoside having a degree of polymerization of 2 or mixtures thereof with the polyglycoside having a degree of polymerization of 3 predominate in relation to the amount of monoglycoside, said composition having an average degree of polymerization of about 1.8 to about 3. Such compositions, also known as peaked alkyl polyglycosides, can be prepared by separation of the monoglycoside from the original reaction mixture of alkyl monoglycoside and alkyl polyglycoside after removal of the alcohol. This separation may be carried out by molecular distillation and normally results in the removal of about 70-95% by weight of the alkyl monoglycosides. After removal of the alkyl monoglycosides, the relative distribution of the various components, mono- and poly-glycosides, in the resulting product changes and the concentration in the product of the polyglycosides relative to the monoglycoside increases as well as the concentration of individual polyglycosides to the total, i.e. DP2 and DP3 fractions in relation to the sum of all DP fractions. Such compositions are disclosed in U.S. Pat. No. 5,266,690, the entire contents of which are incorporated herein by reference.

The most preferred alkyl polyglycoside for use in the present invention is TRITON® GC-110.

In addition to the surfactants disclosed above, other surface active agents can also be used, either in place of, or in addition to, the above described surfactants. Examples of such other surfactants are disclosed in U.S. Pat. No. 6,139,859, which is expressly incorporated herein by reference.

The thickening agents of component D) include polyacrylic acid polymers, available from B. F. Goodrich Chemical Corporation as CARBOPOL® polymers. CARBOPOL® 940 (Carbomer 940) is a water-soluble polyacrylic acid polymer which acts as a thickener and gel-former, CARBOPOL® 934P (Carbomer 934P) is preferred for use herein, which is an essentially benzene-free version of CARBOPOL® 940.

Other thickening agents that can be used include, but are not limited to, sodium carboxymethyl-cellulose, ethoxylated cellulose, hydroxy-propylcellulose, hydroxyethyl cellulose, glyceryl monostearate, hydroxyethyl stearyl amide, ethylene glycol monostearate, stearic diethanolamide, coconut fatty acid diethanolamide, lauric diethanolamide, lauric/myristic diethanolamide, guar hydroxypropyl trimonium chloride, ethylene glycol distearate, n-octadecanol, lauric monoisopropanolamide, isostearamidopropyl betaine, PEG (400-1000) mono- or di-stearates, glycerol dioleate, alkali metal alginates, xanthan gum, and the like.

Component F) can be a pharmacologically compatible base, such as sodium or potassium carbonate, or an amine such as triethanolamine or an acidic component such as sodium bisulfate.

The component G) preservatives can be used if needed. For example when component A) is benzyl alcohol, the benzyl alcohol also acts as a preservative. Other preservatives can be added if desired, such as parabens, imidurea, and the like.

With respect to component E) (water), preferred are compositions in which the quantity of water is in the range of from 60 to 95% by weight, more preferably from 70 to 95% by weight, and most preferably from 69 to 93% by weight.

Compositions of the invention can be prepared by adding components A), B) and C) to component E) at room temperature with mixing. Then component D) is added with mixing, followed by optional components F) and G) if needed or desired. The pH of the mixture is preferably 7±0.5.

With respect to the method of treatment described in the SUMMARY OF THE INVENTION in step I), a coating of the composition is applied to the infected skin (and hair), either by hand or by a suitable applicator. In the case of head lice, the composition is preferably massaged onto human dry hair and scalp.

In step II), the composition is allowed to remain in contact with the scalp or other skin area until the parasites and their eggs are dead from pesticidal activity alone or from a combination of suffocation and pesticidal activity, e.g. from 10 to 45 minutes, usually from 10 to 15 minutes.

In step III), the composition is then readily and rapidly removed, e.g. by rinsing with water.

The above treatment will kill all motile stages of the lice and other ectoparasites, as well as most and generally all of the ectoparasite eggs, and hence a repeat treatment will probably not be necessary. However, the above procedure can be repeated after seven to ten day intervals, to kill any lice that may have hatched from viable nits. Usually, however, the above repeat procedure need not be carried out at all.

The invention will be illustrated but not limited by the following examples.

### EXAMPLES

### Example 1

The following composition was prepared:

| Component | % by weight |
|---|---|
| Distilled water | 88.25 |
| Benzyl Alcohol, NF | 5.00 |
| Mineral Oil, NF | 5.00 |
| TRITON ® GC-110 | 1.00 |
| CARBOPOL ® 940, NF | 0.25 |
| Trolamine, NF | 0.50 |
| | 100.00 |

*triethanolamine - added in the quantity shown or until a pH of 7 ± 0.5 is obtained.

The above composition was prepared by adding the benzyl alcohol, mineral oil and TRITON® GC-110 to the distilled water with mixing. Then the CARBOPOL® 940 was added with vigorous mixing for 30 minutes. Trolamine was added slowly with slow mixing until a pH of 7.0±0.5 was obtained. The mixture was in the form of a gel. Slow mixing was continued until the gel was uniform to minimize air entrapment.

### Example 2

The following composition was prepared:

| Component | % by weight |
|---|---|
| Distilled water | 88.25 |
| Benzyl Alcohol, NF | 5.00 |
| Mineral Oil, NF | 5.00 |
| TRITON ® GC-110 | 1.00 |
| CARBOPOL ® 940, NF | 0.25 |
| Trolamine, NF | 0.50 |
| Methylparaben, NF | 0.15 |
| Propylparaben, NF | 0.05 |
| Imidurea, NF | 0.20 |
| | 100.00 |

*triethanolamine - added in the quantity shown or until a pH of 7 ± 0.5 is obtained.

The above composition was prepared by heating the distilled water to 70° C. and adding the methylparaben, propylparaben and imidurea with mixing until the solids dissolved. The mixture was cooled to room temperature. Then the benzyl alcohol, mineral oil and TRITON® GC-110 were added with mixing. The CARBOPOL® 940 was added with vigorous mixing for 30 minutes. Trolamine was added slowly with slow mixing until a pH of 7.0±0.5 was obtained. The mixture was in the form of a gel. Slow mixing was continued until the gel was uniform to minimize air entrapment.

### Example 3

The composition of Example 1 was prepared, to which is then added with mixing 10% by weight, based on the weight of the composition, of 1% by weight of a combination of oxidoreductase, transferase, lyase, hydrolase, isomerase, and ligase in 9% by weight of water.

### Example 4

The composition of Example 1 was evaluated clinically, according to the following protocol:

After informed consent was obtained, twenty participants were enrolled in the study. Nineteen subjects completed all visits. One subject was dropped from the study after her mother shaved her head due to the “no nit policy” at the child's school.

Prior to treatment (Day 1), participants were visually evaluated for the number of viable lice and nits prior to treatment. A timed ten-minute application of the study product was then applied to thoroughly saturate the subject's hair (1-2 bottles depending on length). Immediately afterwards, the hair was rinsed with water, shampooed, rinsed and combed (with a wide-toothed comb). The rinse water was strained through a flour sack, cotton kitchen towel to collect and count the number of live or dead lice and nymphs present after the procedure.

One week later (Day 8), the above procedures were repeated for each subject. Therefore, each subject had two, ten-minute treatments one week apart in order to kill any nymphs that might have hatched after treatment.

A final evaluation was conducted on Day 15 through visual inspection. Nit removal was not conducted during the two-week study period. There were no adverse experiences (AE), and subject comments reflected satisfaction with regard to safety, efficacy and cosmetic acceptability.

There were a total of 20 females enrolled in the study. Most were heavily infested, some with hundreds of lice. Participants ranged from 5 to 35 years of age and had a mean age of 11.55 years (±8.19 years). The mean height for all participants was 128.93 cm (±20.97 cm). The mean weight from all participants was 88.61 lbs (±42.3 lbs). See Table 1 below.

TABLE 1
Demographic Profile

| Age | Mean | | Mean | Std. Dev. | Mean | Std. Dev. |
|---|---|---|---|---|---|---|
| Range | Age | Std. Dev. | Height | Of | Weight | Of |
| (years) | (years) | Of Ages | (cm) | Heights | (lbs.) | Weights |
| 5 to 35 | 11.55 | ±8.19 | 128.93 | ±20.97 | 88.61 | ±42.3 |

Methods

The protocol and informed consent was approved by the Southern IRB, Miami, Fla. The study was conducted at Lice Source Services from Oct. 4-25, 2001. Informed consent was obtained from subjects or their parents/guardians prior to enrollment. Participation was voluntary. Subject eligibility was determined by the presence of at least 5 live lice detected by visual inspection. Family members were included if they fit the eligibility criteria. This was an open-label pilot study, and all patients received the same treatment. See Tables 2 and 3 for baseline data.

The Lice Source Service investigation team administered all treatments. Safety was evaluated by a scalp examination conducted before initial treatment and immediately after each treatment.

Pediculicidal efficacy was determined by the absence of live lice on day 8 (±1 day) and day 15 (±2 days) after initial treatment. After the first and second treatments, the rinse water was collected and strained through a flour-sack kitchen towel. The towels were examined for any lice using a 6× lighted magnifier. If the subject had no live lice at the end of the study (day 15) they were scored as a TREATMENT SUCCESS.

The shampoo, comb, rinse, and straining method has been found, in our experience, to be more accurate in detecting lice than visual inspection. The number of lice and nymphs and their viability was recorded on the CRF.

TABLE 2
Severity of Infestations of Subjects at Baseline

| Severity | Lice* | Nits** |
|---|---|---|
| Mild | 5 | 0 |
| Moderate | 5 | 2 |
| Severe | 9 | 17 |
| Total | 19 | 19 |

*Lice: <10 = Mild; 10-15 = Moderate; >15 = Severe
**Nits: <10 = Mild; 11-19 = Moderate; 20-100's = Severe

TABLE 3
Stages of Lice in Subjects at Baseline

| | All |
|---|---|
| Adults Only | 1 |
| Nymphs Only | 0 |
| All Stages | 18 |
| Total | 19 |

Results

As per the study protocol, pediculicidal activity was assessed at Day 8. Eighteen subjects had no live lice at Day 8. The other remaining subject had one live nymph, indicating that the product appears to have excellent ovicidal activity. All study participants were evaluated at Day 8, and were given a second treatment regardless of whether or not they had live lice. At the final follow up (Day 15), each participant was determined to be a treatment success. See Table 4 below.

TABLE 4
Treatment Success Rates of the Composition of Example 1

| Total # of completed | Rx Success at Day 15 | % Rx Success at Day 15 |
|---|---|---|
| 19 | 19 | 100% |

### CONCLUSIONS

This open label pilot study in a population heavily infested with Pediculus capitis demonstrates that two treatments of 10 minutes each of the composition of Example 1 was 100% effective. The product had excellent cosmetic acceptability by the LSS staff and the participants since it had no odor, was easy to use, and left the hair shiny and manageable.

### Example 5

The following compositions were prepared:

| | |
|---|---|
| Component | % by weight |

| | | |
|---|---|---|
| Distilled water | 88.25 | 88.25 |
| Benzyl Alcohol, NF | 5.00 | 5.00 |
| Mineral Oil, NF | 5.00 | 5.00 |
| TRITON ® GC-110 | 1.00 | N/A |
| Polysorbate 80, NF (TWEEN ® 80) | N/A | 0.60 |
| Sorbitan Monooleate, NF (SPAN ® 80) | N/A | 0.40 |
| Carbomer 940, NF | 0.25 | N/A |
| Carbomer 934P, NF | N/A | 0.25 |
| Trolamine, NF* | 0.50 | 0.50 |
| TOTAL | 100.00 | 100.00 |

*Or sufficient to provide for pH of 7.0

The above compositions were prepared by adding the benzyl alcohol, mineral oil, and TRITON® GC-110 or Polysorbate 80, NF and Sorbitan monooleate, NF to the distilled water with mixing. Then the Carbomer 940, NF or Carbomer 934P, NF was added with vigorous mixing for 30 minutes. Trolamine was added slowly with slow mixing until a pH of 7.0±0.5 was obtained. The mixtures were in the form of a gel. Slow mixing was continued until the gel was uniform to minimize air entrapment.

The above compositions were formulated to provide rapid water rinse-off after about a 10 minute application.

### Example 6

The following composition was prepared:

| Component | % by weight |
|---|---|
| Distilled water | 93.25 |
| Benzyl Alcohol, NF | 5.00 |
| Polysorbate 80, NF (TWEEN ® 80) | 0.60 |
| Sorbitan Monooleate, NF (SPAN ® 80) | 0.40 |
| Carbomer 934P, NF | 0.25 |
| Trolamine, NF* | 0.50 |
| TOTAL | 100.00 |

*Or sufficient to provide for pH of 7.0

The above composition was prepared by adding the benzyl alcohol and Polysorbate 80, NF and Sorbitan monooleate, NF to the distilled water with mixing. Then the Carbomer 934P, NF was added with vigorous mixing for 30 minutes. Trolamine was added slowly with slow mixing until a pH of 7.0±0.5 was obtained. Slow mixing was continued until the composition was uniform to minimize air entrapment.

### Example 7

The compositions of Example 5 (second formulation) and 6 were tested for their ability to kill nits (the nits of head lice). The nits were treated in vitro for 10 minutes, and compared to nits treated in vitro with plain water as a control. The results obtained are set forth in Table 5 below:

TABLE 5
Ovicidal data for head lice nits

| | No. of nits | No. of nits not | No. of nits | No. of nits |
|---|---|---|---|---|
| Composition | tested | hatched | stillborn | hatched |
| control (water) | 10 | 0 | 1 | 9 |
| Ex. 5 | 10 | 6 | 2 | 2 |
| Ex. 6 | 10 | 6 | 2 | 2 |
| control (water) | 10 | 1 | 1 | 8 |
| Ex. 5 | 10 | 10 | 0 | 0 |
| Ex. 5 | 9 | 9 | 0 | 0 |
| Ex. 5 | 10 | 10 | 0 | 0 |
| Ex. 6 | 10 | 10 | 0 | 0 |
| Ex. 6 | 9 | 9 | 0 | 0 |

In the above table, there were 20 controls, from which 17 nits hatched, i.e. a hatch rate of 85% (17÷20). With respect to the Example 5 composition, from 39 nits only 2 hatched, i.e. a hatch rate of 5.1%. With respect to the Example 6 composition, from 29 nits only 2 hatched, i.e. a hatch rate of 6.9%.

The ovicidal activity is calculated by dividing the number of nits that did not hatch plus those that were stillborn by the number tested. For the control the ovicidal activity was 15%. For the composition of Example 5 (second formulation), the ovicidal activity was 94.9%. For the composition of Example 6, the ovicidal activity was 93.1%.

### Example 8

The following composition was prepared:

| Component | quantity, g | % by weight |
|---|---|---|
| Distilled water | 792.5 | 79.25 |
| Benzyl alcohol, NF | 100.0 | 10.00 |
| Mineral Oil, 5 lt., NF | 50.0 | 5.00 |
| Sorbitan monooleate, NF (SPAN ® 80) | 25.0 | 2.50 |
| Polysorbate 80, NF (TWEEN ® 80) | 25.0 | 2.50 |
| Carbomer 934P, NF (CARBOPOL ® 934P) | 2.5 | 0.25 |
| Triethanolamine, NF | 5.0 | 0.50* |
| TOTAL | 1000.0 | 100.00 |

*or quantity needed to obtain pH 7.0.

The above composition was prepared by adding the first five components to a mixer in the order shown in the table. A white emulsion was obtained. The emulsion was stirred for 15 minutes. Then the mixer speed was increased to form a vortex, and the Carbomer 934P was added slowly to give a good dispersion, and the dispersion was stirred for an additional 30 minutes. Triethanolamine was added to obtain a pH of 7.0±0.5. The mixture gelled, followed by slow stirring to minimize air entrapment. A very smooth uniform gel was obtained.

### Example 9

The following composition was prepared:

| Component | quantity, kg | % by weight |
|---|---|---|
| Distilled water | 742.5 | 74.25 |
| Benzyl alcohol, NF | 150.0 | 15.00 |
| Mineral Oil, 5 lt., NF | 50.0 | 5.00 |
| Sorbitan monooleate, NF (SPAN ® 80) | 25.0 | 2.50 |
| Polysorbate 80, NF (TWEEN ® 80) | 25.0 | 2.50 |
| Carbomer 934P, NF (CARBOPOL ® 934P) | 2.5 | 0.25 |
| Triethanolamine, NF | 5.0 | 0.50* |
| TOTAL | 1000.0 | 100.00 |

*or quantity needed to obtain pH 7.0.

The above composition was prepared according to the process of Example 8.

The resulting composition was in the form of a smooth, uniform gel.

### Example 10

The following composition was prepared:

| Component | quantity, g | % by weight |
|---|---|---|
| Distilled water | 692.5 | 69.25 |
| Benzyl alcohol, NF | 200.0 | 20.00 |
| Mineral Oil, 5 lt., NF | 50.0 | 5.00 |
| Sorbitan monooleate, NF (SPAN ® 80) | 25.0 | 2.50 |
| Polysorbate 80, NF (TWEEN ® 80) | 25.0 | 2.50 |
| Carbomer 934P, NF (CARBOPOL ® 934P) | 2.5 | 0.25 |
| Triethanolamine, NF | 5.0 | 0.50* |
| TOTAL | 1000.0 | 100.00 |

*or quantity needed to obtain pH 7.0.

The above composition was prepared according to the process of Example 8.

The resulting composition was in the form of a gel, which was, however, not completely uniform.

### Example 11

The following composition is prepared:

| Component | quantity, g | % by weight |
|---|---|---|
| Distilled water | 592.5 | 59.25 |
| Benzyl alcohol, NF | 300.0 | 30.00 |
| Mineral Oil, 5 lt., NF | 50.0 | 5.00 |
| Sorbitan monooleate, NF (SPAN ® 80) | 25.0 | 2.50 |
| Polysorbate 80, NF (TWEEN ® 80) | 25.0 | 2.50 |
| Carbomer 934P, NF (CARBOPOL ® 934P) | 2.5 | 0.25 |
| Triethanolamine, NF | 5.0 | 0.50* |
| TOTAL | 1000.0 | 100.00 |

*or quantity needed to obtain pH 7.0.

The above composition is prepared according to the process of Example 8.

The resulting product is in the form of a liquid rather than in gel form.

What is claimed is:

1. A water-soluble or water-dispersible pharmacologically acceptable liquid or gel form composition comprising the following components:
A) a quantity of at least one pesticidally-active monohydric aralkyl alcohol sufficient to provide pesticidal activity against ectoparasites and their eggs; and
B) at least one of the following components;
a film forming agent,
a surface active agent,
a gelling or thickening agent.

2. The composition of claim 1 wherein the composition contains from about 1 to about 50% by weight of at least one monohydric aralkyl alcohol, based on the weight of the composition.

3. The composition of claim 1 wherein the composition contains from about 2 to about 30% by weight of at least one monohydric aralkyl alcohol.

4. The composition of claim 1 wherein the composition contains from about 5 to about 20% by weight of at least one monohydric aralkyl alcohol.

5. The composition of claim 1 wherein the composition contains from about 5 to about 12% by weight of at least one monohydric aralkyl alcohol.

6. The composition of claim 1 wherein the at least one monohydric aralkyl alcohol has the formula I below: 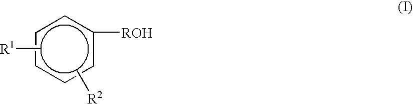
wherein R is a C₁-C₁₂ straight or branched chain, saturated or olefinically unsaturated alkylene group, and R₁ and R² are independently selected from the group consisting of hydrogen, halogen, C₁-C₄ alkyl, and C₁-C₄ alkoxy groups.

7. The composition of claim 6 wherein R is a C₁-C₆ saturated alkylene group.

8. The composition of claim 6 wherein the compound of formula I is benzyl alcohol.

9. The composition of claim 8 wherein the composition contains from about 1 to about 50% by weight of benzyl alcohol.

10. The composition of claim 8 wherein the composition contains from about 2 to about 30% by weight of benzyl alcohol.

11. The composition of claim 8 wherein the composition contains from about 5 to about 20% by weight of benzyl alcohol.

12. The composition of claim 8 wherein the composition contains from about 5 to about 12% by weight of benzyl alcohol.

13. The composition of claim 1 wherein the composition is a water-containing gel.

14. The composition of claim 13 wherein the composition contains all of the component B) components.

15. The composition of claim 8 wherein the composition does not contain any pesticides other than component A).

16. A water-soluble or water-dispersible, substantially air-impermeable, pharmacologically acceptable, liquid barrier composition for treating ectoparasite infestations in the animal body comprising the following components:
A) at least one pesticidally-active aralkyl alcohol in a quantity sufficient to provide pesticidal activity against both the ectoparasites and the eggs therefrom, and to prevent the ectoparasites from closing their respiratory systems; and
B) at least one of the following components:
a film forming agent;
a surface active agent;
a gelling or thickening agent.

17. The composition of claim 16 wherein the composition is free from pesticides other than the at least one aralkyl alcohol.

18. The composition of claim 16 in which component A) is present in a quantity sufficient to prevent a head louse from closing its spiracle and to provide pediculicidal activity against the head louse and its nits.

19. The composition of claim 18 wherein the animal body is the body of a human being.

20. The composition of claim 16 wherein component A) is present in from about 1 to about 50% by weight of the composition.

21. The composition of claim 16 wherein component A) is present in from about 2 to about 30% by weight; component B) is present in from about 1 to about 25% by weight; component C) is present in from about 0.1 to about 10% by weight; and component D) is present in from about 0.05 to about 5% by weight, based on the weight of the composition.

22. The composition of claim 21 wherein component A) is present in from about to about 20% by weight; component B) is present in from about 2 to about 10% by weight; component C) is present in from about 0.5 to about 6% by weight; and component D) is present in from about 0.1 to about 3% by weight; based on the weight of the composition.

23. The composition of claim 21 wherein component A) is present in from about 5 to about 12% by weight; component B) is present in from about 3 to about 7% by weight; component C) is present in from about 0.8 to about 5% by weight; and component D) is present in from about 0.15 to about 1% by weight; based on the weight of the composition.

24. The composition of claim 16 wherein in component A) the at least one monohydric aralkyl alcohol has the formula I below: 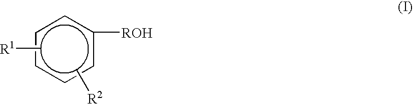
wherein R is a C₁-C₁₂ straight or branched chain, saturated or olefinically unsaturated alkylene group, and R¹ and R² are independently selected from the group consisting of hydrogen, halogen, C₁-C₄ alkyl, or C₁-C₄ alkoxy groups.

25. The composition of claim 16 wherein R is a C₁-C₆ saturated alkylene group.

26. The composition of claim 16 wherein the compound of formula I is benzyl alcohol.

27. The composition of claim 23 wherein the composition contains from about 1 to about 50% by weight of benzyl alcohol.

28. The composition of claim 23 wherein the composition contains from about 2 to about 30% by weight of benzyl alcohol.

29. The composition of claim 16 wherein the surface active agent is a polysorbate surfactant and/or a sorbitan monofatty acid ester.

30. The composition of claim 16 wherein the film forming agent is an oil and the surface active agent is a mixture of a polysorbate and a sorbitan monofatty acid ester.

31. The composition of claim 16 wherein water is present in from about 60 to about 95% by weight, based on the weight of the composition.

32. The composition of claim 16 wherein the composition comprises the following components:

| Component | % by weight |
|---|---|
| Distilled water | from about 60 to about 95 |
| Benzyl alcohol | from about 2 to about 20 |
| Mixture of a polysorbate and a | from about 0.1 to about 10 |
| sorbitan monofatty acid ester | |
| Thickening agent | from about 0.05 to about 5 |
| Triethanolamine | to obtain pH 7 ± 0.5 |

33. A method for the topical treatment of ectoparasites on animal skin comprising the steps of:
A) applying to the skin and hair containing ectoparasites a pesticidal-effective quantity of a pharmacologically acceptable composition comprising at least one pesticidally-active monohydric aralkyl alcohol;
B) leaving the composition in contact with the skin and hair until the ectoparasites and at least most of their eggs have been killed; and
C) removing the composition and the dead ectoparasites from the skin and hair.

34. The method of claim 33 wherein the ectoparasite is the head louse.

35. The method of claim 33 wherein the composition is in the form of a liquid or a gel.

36. The method of claim 33 wherein in step B) the composition is left in contact with the skin for a period of at least about 10 minutes.

37. The method of claim 33 wherein the time period is from about 10 minutes to about 45 minutes.

38. The method of claim 33 wherein in step C) the composition and dead ectoparasites are removed by rinsing with water.

39. The method of claim 30 wherein the at least one monohydric aralkyl alcohol has the formula: 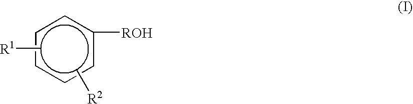
wherein R is a C₁-C₁₂ straight or branched chain, saturated or olefinically unsaturated alkylene group, and R¹ and R² are independently selected from the group consisting of hydrogen, halogen, C₁-C₄ alkyl, or C₁-C₄ alkoxy groups.

40. The method of claim 39 wherein R is a C₁-C₆ saturated alkylene group.

41. The method of claim 39 wherein the compound of formula I is benzyl alcohol.

42. The method of claim 39 wherein the composition contains from about 1 to about 50% by weight of benzyl alcohol.

43. The method of claim 39 wherein the composition contains from about 2 to about 30% by weight of benzyl alcohol.

44. A method for the topical treatment of lice and their nits on animal skin comprising the steps of:
A) applying to animal skin and hair containing ectoparasites a water-soluble or water-dispersible, substantially air-impermeable, pharmacologically acceptable, liquid barrier composition containing a quantity of at least one pesticidally-active monohydric aralkyl alcohol sufficient to provide pesticidal activity to kill the lice and at least most of their nits, and to suffocate the lice by preventing the lice from closing their spiracles and from obtaining oxygen, wherein the liquid composition can range from a liquid to a gel;
B) leaving the composition in contact with the skin and hair until the lice and at least most of their nits have been killed; and
C) removing the composition and the dead lice from the skin and hair;

45. The method of claim 44 wherein the animal is a human being.

46. The method of claim 44 wherein the lice are head lice.

47. The method of claim 44 wherein the at least one monohydric aralkyl alcohol is the only pesticidal component of the composition.

48. The method of claim 44 wherein the composition is in the form of a gel.

49. The method of claim 44 wherein in step B) the composition is left in contact with the skin for a period of at least about 10 minutes.

50. The method of claim 44 wherein the time period is from about 10 minutes to about 45 minutes.

51. The method of claim 44 wherein in step C) the composition and dead ectoparasites are removed by rinsing with water.

52. The method of claim 44 wherein the at least one monohydric aralkyl alcohol has the formula: 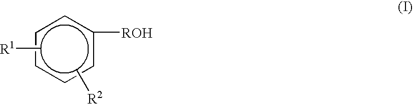
wherein R is a C₁-C₁₂ straight or branched chain, saturated or olefinically unsaturated alkylene group, and R¹ and R² are independently selected from the group consisting of hydrogen, halogen, C₁-C₄ alkyl, or C₁-C₄ alkoxy groups.

53. The method of claim 52 wherein R is a C₁-C₆ saturated alkylene group.

54. The method of claim 52 wherein the compound of formula I is benzyl alcohol.

55. The method of claim 52 wherein the compound consists essentially of benzyl alcohol.

56. The method of claim 52 wherein the composition contains from about 1 to about 50% by weight of benzyl alcohol.

57. The method of claim 52 wherein the composition contains from about 2 to about 30% by weight of benzyl alcohol.
